(19) United States
(12) Patent Application Publication
(10) Pub. No.: US 2008/0244261 A1
(43) Pub. Date: Oct. 2, 2008

(54) SEPARATION OF LOGICAL TRUSTED PLATFORM MODULES WITHIN A SINGLE PHYSICAL TRUSTED PLATFORM MODULE

(76) Inventors: Willard M. Wiseman, Tigard, OR (US); David W. Grawrock, Aloha, OR (US)

Correspondence Address: INTEL CORPORATION;c/o INTELLEVATE, LLC, P.O. BOX 52050, MINNEAPOLIS, MN, 55402, US

(21) Appl. No.: 11/693,242

(22) Filed: Mar. 29, 2007

(51) Int. Cl. H04L 9/00

(52) U.S. Cl. 713/155

(57) ABSTRACT

A device, method, and system are disclosed. In one embodiment, the device includes storage to contain more than one trust root, and logic to associate each command ordinal sent to the device with one of the trust roots.

### FIELD OF THE INVENTION

The invention relates to trusted platforms. More specifically, the invention relates to logical and physical trusted platform modules (TPMs).

### BACKGROUND OF THE INVENTION

Computer security issues are becoming more widespread as an ever-increasing number of diverse computer applications are developed. Problems such as viruses, worms, spyware, and theft are plaguing the population of computer users. Additionally, as the Internet connects more people to each other, it also is fueling security problems because confidential information is more easily compromised.

A number of technology companies are promoting and contributing to the Trusted Computing Group, which develops, defines, and promotes open standards for hardware-enabled trusted computing and security technologies. These technologies include hardware modules and software interfaces that aim to work across multiple platforms. One major development that has become an increasing success is the Trusted Platform Module (TPM) and its set of specifications. The TPM is a module designed to independently handle trust-based operations on a given computer system.

Each TPM has a number of internal functions and hardware to execute them. A TPM may include an execution engine, program code, storage, registers, encryption algorithms and key generators among other items. Detailed information regarding the fundamentals of a TPM is readily available from the Trusted Computing Group organization. Their latest version of the TPM specification is Revision 94 from March 2006.

As TPMs evolve over time, it becomes necessary to handle migration from hardware utilizing one version of the TPM specification to hardware able to utilize the next version. New versions of the specification may require new encryption and hash algorithms among other things. Maintaining backward compatibility for existing applications that use the original algorithms while providing the new algorithms for new applications is important. Also, some computing environments, such as partitioned hardware platforms, may require two sets of algorithms and, therefore, two sets of key material and configuration information.

Currently available TPM designs require a set of key material and configuration information to perform trust operations. In some embodiments, this key material and configuration information is called a Trust Root. Current TPM architecture allows for only one Trust Root per TPM.

### BRIEF DESCRIPTION OF THE DRAWINGS

The present invention is illustrated by way of example and is not limited by the figures of the accompanying drawings, in which like references indicate similar elements, and in which:

FIG. 1 describes one embodiment of a trusted platform module (TPM) device with multiple trusted roots.

FIG. 2 illustrates the current data stored in a TPM command ordinal and the new, repurposed data stored in the TPM command ordinal to allow for multiple logical TPMs.

FIG. 3 is a flow diagram of one embodiment of a process to store multiple Trust Roots and associate them with command ordinals.

FIG. 4 is a flow diagram of one embodiment of a process to receive a command ordinal and use the target Trust Root to execute the ordinal command.

FIG. 5 is a block diagram of a computer system which may be used with embodiments of the present invention.

### DETAILED DESCRIPTION OF THE INVENTION

Embodiments of a device, method, and system to separate logical trusted platform modules within a single physical trusted platform module are described. In the following description, numerous specific details are set forth. However, it is understood that embodiments may be practiced without these specific details. In other instances, well-known elements, specifications, and protocols have not been discussed in detail in order to avoid obscuring the present invention.

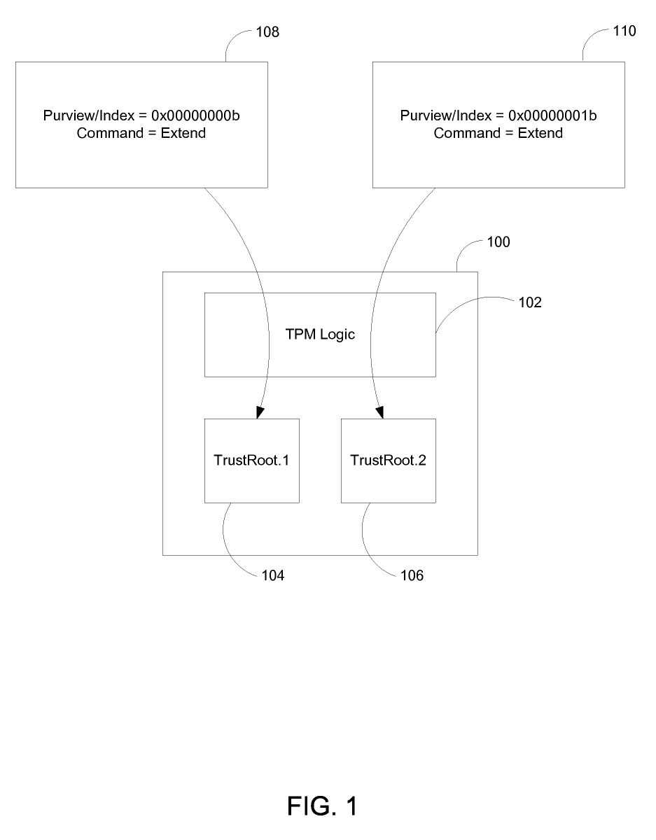

FIG. 1 describes one embodiment of a trusted platform module (TPM) device with multiple trusted roots. In many embodiments, a TPM 100 resides in a computer system to assist in performing trust-based operations. The basic design of TPM 100 has a number of internal components for trust-based computing operations. In different embodiments, the TPM 100 includes an execution engine, program code to run on the execution engine, non-volatile storage, volatile storage, a set of platform configuration registers (PCRs), as well as encryption algorithms/engines, and key generators. A majority of the internal components listed are not shown in FIG. 1 but information regarding general TPM architecture can be readily obtained from the Trusted Computing Group or from numerous TPM data sheets published by the companies that manufacture TPMs.

The TPM 100 in FIG. 1 includes TPM logic 102 and at least two Trust Roots, TrustRoot.1 (104) and TrustRoot.2 (106) stored in memory storage in the TPM 100. In some embodiment, this memory storage for the Trust Roots may be non-volatile memory. In some embodiments, the non-volatile memory may be flash memory. In different embodiments, TPM logic 102 may include hardware, software, or a combination of both. TPM logic 102 receives command ordinals as input, also referred to as 4-byte TPM_COMMAND_CODE operands. A command ordinal is an index that points to a specific trusted computing operation stored within the TPM.

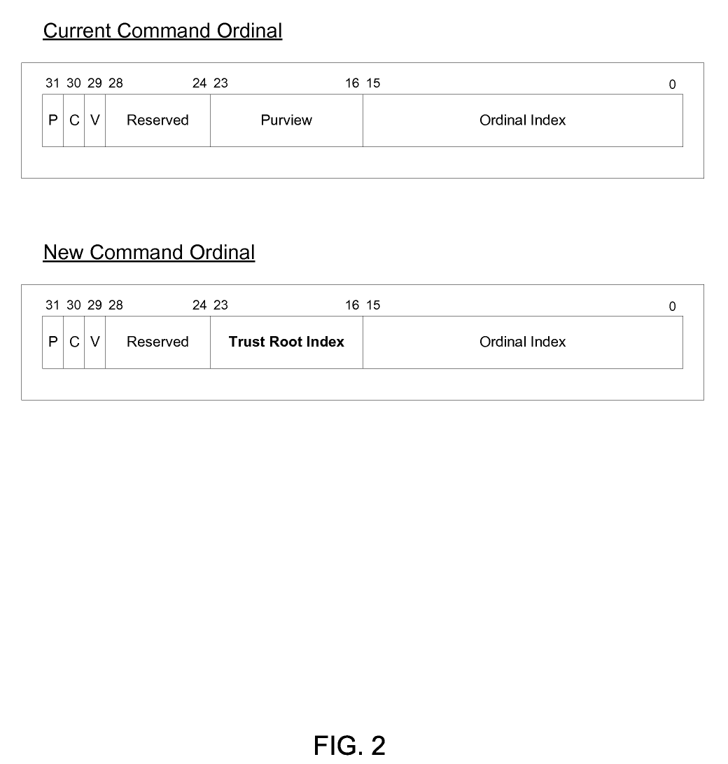

Turning to FIG. 2 for a moment, FIG. 2 illustrates the current data contained within a TPM command ordinal and the new, repurposed data stored in the TPM command ordinal to allow for multiple logical TPMs. In one embodiment, the current data stored in the TPM command ordinal includes P (bit 31) which notifies whether or not the command is protected. Next, T (bit 30) notifies whether the command passes through to either protected or unprotected components. Next, V (bit 29) notifies if the command is TPM defined or vendor defined. Then there are 5 bits (bits 28-24) that are reserved. Next is the 8-bit Purview field (bits 23-16) which was originally designated to indicate which platform the command was designated for. Different platforms could include a desktop computer, mobile computer, personal digital assistant, server, etc. This field has not been made of any use since the TPM spec was originally created. Finally, the 16-bit Ordinal Index field (bits 15-0) is an index pointer to the command to execute in the TPM.

In many embodiments, the data stored in the new TPM command ordinal has been modified from the original version. The unused Purview field has been repurposed with a Trust Root Index field. The Trust Root Index includes an index pointer to a trust root in the TPM.

Returning to FIG. 1, in one embodiment, there are two Trust Roots, TrustRoot.1 (104) and TrustRoot.2 (106) stored within the TPM. In different embodiments, a Trust Root may contain a number of different key materials as well as other personalization and configuration information. Key materials may include TPM owner information as well as TPM user information. In many embodiments, a Trust Root includes at least an Endorsement Key, a Storage Root Key, and a uniqueness proof (a tpmProof). The additional personalization and configuration information may include platform integrity information contained in one or more PCRs in some embodiments. Additionally, one or more attributes of the objects within the Trust Root may be stored within the Trust Root.

The Trust Root, in many embodiments, incorporates trust-related information that allow for trust to be maintained during the execution of instructions, transfer of data, etc. The Endorsement Key refers to the cryptographic uniqueness inside a TPM. The Storage Root Key refers to the cryptographic key that forms part of the Root of Trust for Storage as defined by the Trusted Computing Group. The tpmProof refers to a nonce (a random number) that each TPM maintains to validate that the data originated at this TPM, to the owner of the TPM. In many other embodiments, there may be a number of other trust related keys incorporated into the Trust Root.

While FIG. 1 shows that in this embodiment there is only one physical TPM, each Trust Root stored within the TPM allows the platform and the user working with the platform to utilize the device as a separate and individual logical TPM. Therefore, one physical TPM can contain many logical TPMs, wherein each logical TPM is associated with its own Trust Root stored within the physical TPM.

Each Trust Root is unique. Since FIG. 1 has two completely independent Trust Roots, each command ordinal received by the TPM 100 would be required to notify which Trust Root is to be used when the command is executed. For example, a command ordinal 108 is received by the TPM 100 and the ordinal index points to a command. In this particular example, the ordinal index points to the Extend command, though in other embodiments, the ordinal index may point to any valid trusted computing operation stored within the TPM. The Purview field, which has been repurposed into the Trust Root Index field is set to 0 (0x00000000b). Therefore, TPM Logic 102 receives the command ordinal 108, determines the value of the Purview/Trust Root Index field is 0, and utilizes TrustRoot.1 for execution of that command (i.e. index 0 points to TrustRoot.1).

Alternatively, a command ordinal 110 is received by the TPM 100 and the ordinal index points to a command, in this example the ordinal index points to the Extend command again. But, in the command ordinal 110, the Purview/Trust Root Index field is set to 1 (0x00000001b). Therefore, TPM Logic 102 receives the command ordinal 110, determines the value of the Purview/Trust Root Index field is 1, and utilizes TrustRoot.2 for execution of that command (i.e. index 1 points to TrustRoot.2). The Extend command was used specifically as an example command, in many other embodiments, any TPM-based command can be executed by the logical TPM that is targeted.

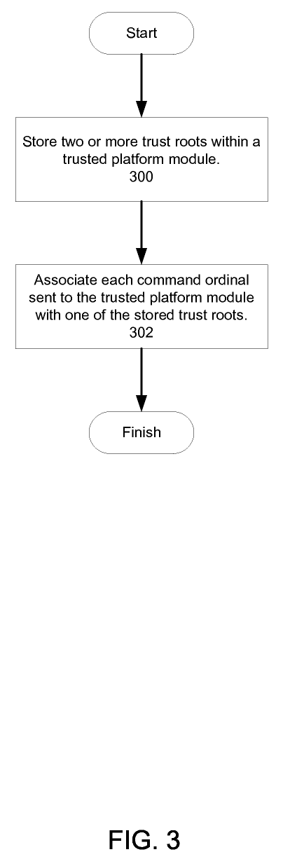

FIG. 3 is a flow diagram of one embodiment of a process to store multiple Trust Roots and associate them with command ordinals. The process is performed by processing logic that may comprise hardware (circuitry, dedicated logic, etc.), software (such as is run on a general purpose computer system or a dedicated machine), or a combination of both. Referring to FIG. 3, the process begins by processing logic storing two or more trust roots within a single trusted platform module (processing block 300).

Trust Roots are comprised of multiple keys and other trust material, thus, in some embodiments, the Trust Root value is created through a hash function. Each piece of data entered into the Trust Root (i.e. Endorsement Key, Storage Root Key, etc.) is added through the hash function to create a unique Trust Root value. The Trust Root contains various information, some is stored permanently, some is temporary. For example, the Endorsement Key is determined only once for the life of the TPM. The tpmProof is determined only when the ownership of the TPM changes. A contextNonce, a value utilized to allow items to swap in and out of the TPM, is temporary. Additional temporary information, such as the locality of a command, may be stored within a Trust Root. Because some of the information located within the Trust Root is not permanent, the Trust Root information must be stored in memory that is rewriteable. Non-volatile memory within the TPM can accomplish the task of storing permanent information through multiple power downs and also store non-permanent information at each boot.

The process continues with processing logic associating each command ordinal sent to the trusted platform module with one of the stored Trust Roots (processing block 302) and the process is finished.

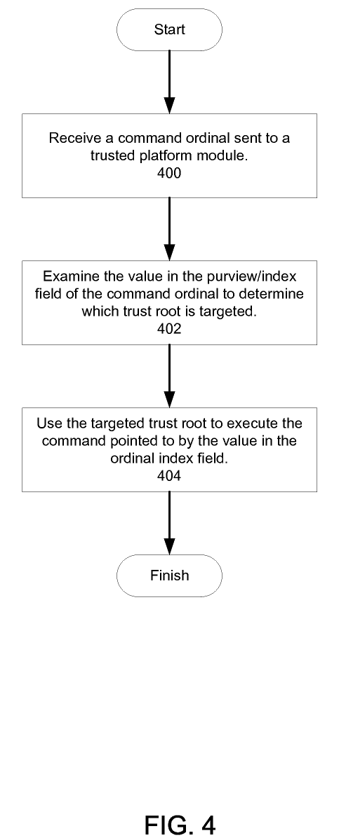

In many embodiments, command ordinals are sent to the TPM so the TPM can perform a trust-based operation. A trust-based operation includes any of the commands stored within the TPM. A list of commands may be found in the latest TPM specification published by the Trusted Computing Group organization. As described in FIG. 2, command ordinals include the Purview/Trust Root Index and Ordinal Index parameters. Furthermore, in some embodiments, processing logic may receive the command ordinal, parse the Purview/Trust Root Index and Ordinal Index out of the command ordinal, and associate the command ordinal (and the parsed Ordinal Index value) with the Trust Root pointed to by the Purview/Trust Root Index value. The set of operations described are shown in the flow diagram in FIG. 4.

Thus, FIG. 4 is a flow diagram of one embodiment of a process to receive a command ordinal and use the target Trust Root to execute the ordinal command. The process is performed by processing logic that may comprise hardware (circuitry, dedicated logic, etc.), software (such as is run on a general purpose computer system or a dedicated machine), or a combination of both. Referring to FIG. 4, the process begins by processing logic receiving a command ordinal sent to a trusted platform module (processing block 400). In one embodiment, the command ordinal is directed to TPM logic within the TPM.

Next, processing logic (in many embodiments this is the TPM logic) examines the value in the Purview/Trust Root Index field (as described in reference to FIG. 2) of the command ordinal to determine which Trust Root is targeted (processing block 402). In some embodiments, processing logic parses the Purview/Trust Root Index value and the Ordinal Index value out of the received command ordinal. With the Purview/Trust Root Index value and the Ordinal Index value available, processing logic can perform a look up for the targeted Trust Root and the targeted command within the non-volatile storage and program code respectively.

Then processing logic uses the targeted trust root to execute the command pointed to by the value in the ordinal index field (processing block 404) and the process is finished. In many embodiments, the trust information referenced by the Trust Root (including key values and other configuration information) are required to execute any TPM-based command in a trusted manner.

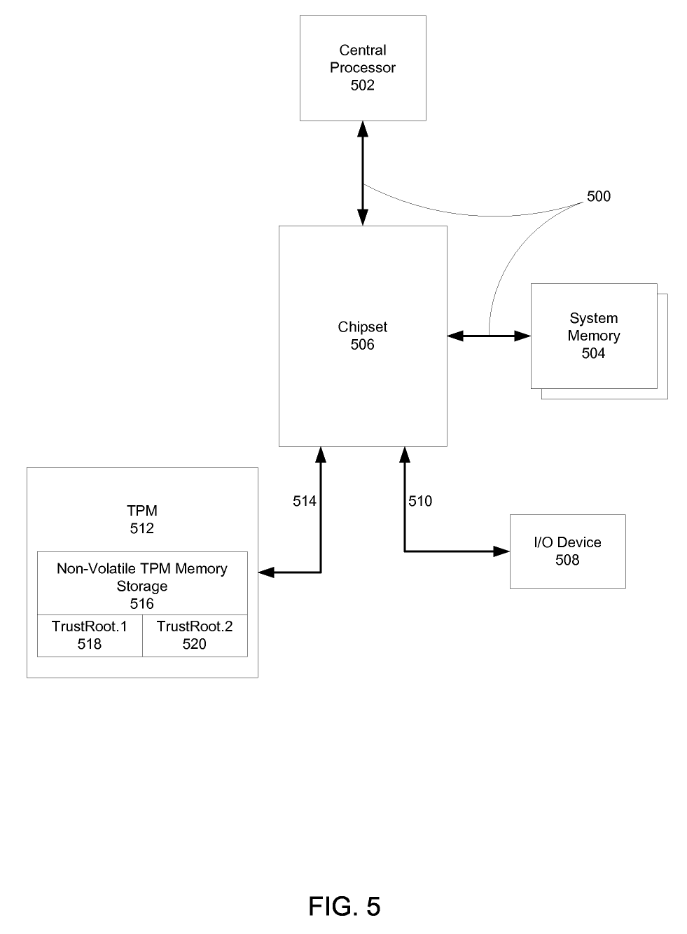

FIG. 5 is a block diagram of a computer system which may be used with embodiments of the present invention. The computer system comprises a processor-memory interconnect 500 for communication between different agents coupled to interconnect 500, such as processors, bridges, memory devices, etc. Processor-memory interconnect 500 includes specific interconnect lines that send arbitration, address, data, and control information (not shown). In one embodiment, central processor 502 is coupled to processor-memory interconnect 500. In another embodiment, there are multiple central processors coupled to processor-memory interconnect (multiple processors are not shown in this figure).

Processor-memory interconnect 500 provides the central processor 502 and other devices access to the system memory 504. A system memory controller controls access to the system memory 504. In one embodiment, the system memory controller is located within the chipset 506 that is coupled to processor-memory interconnect 500. In another embodiment, a system memory controller is located on the same chip as central processor 502 (not shown). Information, instructions, and other data may be stored in system memory 504 for use by central processor 502 as well as many other potential devices.

I/O devices are coupled to the chipset 506 through one or more I/O interconnects. For example I/O device 508 is coupled to the chipset 506 through I/O interconnect 510. In many embodiments, interconnect 510 is a point-to-point interconnect.

In many embodiments, TPM device 512 (TPM) is coupled to chipset 506 through interconnect 514. In different embodiments, interconnect 514 may be a point-to-point interconnect, a broadcast protocol interconnect, a low pin count (LPC) interconnect, or any other valid interconnect. In other embodiments, TPM 512 may be coupled internally to chipset 506 and is located internally within chipset 506 (these embodiments are not shown). In other embodiments, TPM 512 may be located on an external I/O device such as I/O device 508 (not shown). In many embodiments, TPM 512 manages the trust of the computer system. TPM 512 includes internal storage to store important information. In many embodiments, this storage includes non-volatile TPM memory storage 516. In many embodiments, non-volatile TPM memory storage 516 comprises flash memory. In many embodiments, TPM 512 has internal logic that can be utilized to store multiple Trust Roots within the TPM storage to create multiple logical TPMs within the single physical TPM 512. For example, in one embodiment, TrustRoot.1 (518) and TrustRoot.2 (520) are stored within the non-volatile TPM memory storage.

In many embodiments, command ordinals sent to TPM 512 from other locations within the computer system target individual logical TPMs stored within the physical TPM 512 by sending Trust Root Index pointers within the Purview/Trust Root Index value within each command ordinal. Logic within the TPM 512 can, in turn, execute the TPM-based command, pointed to by the Ordinal Index value within the command ordinal, with the correct Trust Root (i.e. logical TPM).

Thus, embodiments of a device, method, and system to separate logical trusted platform modules within a single physical trusted platform module are described. These embodiments have been described with reference to specific exemplary embodiments thereof. It will be evident to persons having the benefit of this disclosure that various modifications and changes may be made to these embodiments without departing from the broader spirit and scope of the embodiments described herein. The specification and drawings are, accordingly, to be regarded in an illustrative rather than a restrictive sense.

What is claimed is:

1. A device, comprising:
storage to contain a plurality of trust roots; and
logic to associate each command ordinal sent to the device with one of the plurality of trust roots.

2. The device of claim 1, wherein the device comprises a trusted platform module (TPM).

3. The device of claim 2, wherein each command ordinal comprises:
an ordinal index to point to the command; and
a purview value, wherein the purview value is repurposed to point to one of the plurality of trust roots.

4. The device of claim 3, wherein the repurposed purview comprises a trust root index.

5. The device of claim 3, further comprising logic to:
receive each command ordinal sent to the device;
determine which trust root the command ordinal is targeting by examining the purview value; and
execute the command pointed to by the ordinal index, wherein the targeted trust root is used during execution.

6. The device of claim 2, wherein each trust root comprises:
an Endorsement Key;
a Storage Root Key;
a uniqueness proof, and
one or more additional pieces of key information and configuration information.

7. The device of claim 1, wherein the storage comprises non-volatile flash memory.

8. A method, comprising:
storing a plurality of trust roots within a trusted platform module (TPM) device; and
associating each command ordinal sent to the device with one of the plurality of trust roots.

9. The method of claim 8, wherein each command ordinal comprises:
an ordinal index to point to the command; and
a purview value, wherein the purview value is repurposed to point to one of the plurality of trust roots.

10. The method of claim 9, wherein the repurposed purview comprises a trust root index.

11. The method of claim 9, further comprising:
receiving each command ordinal sent to the device;
determining which trust root the command ordinal is targeting by examining the purview value; and
using the targeted trust root to execute the command pointed to by the ordinal index.

12. The method of claim 8, wherein each trust root comprises:
an Endorsement Key;
a Storage Root Key; and
a uniqueness proof, and
one or more additional pieces of key information and configuration information.

13. The method of claim 8, wherein the storage comprises non-volatile flash memory.

14. A system, comprising:
a first interconnect;
a processor coupled to the first interconnect;
memory coupled to the first interconnect;
a second interconnect, wherein the second interconnect comprises a point-to-point interconnect;
a chipset coupled to the first and second interconnects; and
a device coupled to the chipset, the device comprising
storage to contain a plurality of trust roots; and
logic to associate each command ordinal sent to the device with one of the plurality of trust roots.

15. The system of claim 14, wherein the device comprises a trusted platform module (TPM).

16. The system of claim 15, wherein each command ordinal comprises:
an ordinal index to point to the command; and
a purview value, wherein the purview value is repurposed to point to one of the plurality of trust roots.

17. The system of claim 16, wherein the device further comprises logic to:
receive each command ordinal sent to the device;
determine which trust root the command ordinal is targeting by examining the purview value; and
execute the command pointed to by the ordinal index, wherein the targeted trust root is used during execution.

18. The system of claim 14, wherein each trust root comprises:
an Endorsement Key;
a Storage Root Key; and
a uniqueness proof; and
one or more additional pieces of key information and configuration information.

19. The system of claim 14, wherein the storage comprises non-volatile flash memory.

20. The system of claim 14, further comprising one or more additional processors coupled to the first interconnect.
